(19) United States
(12) Patent Application Publication
(10) Pub. No.: US 2011/0045198 A1
(43) Pub. Date: Feb. 24, 2011

(54) Powder Size

(75) Inventor: Angelos Psimenos, Bad Erlach (AT)

Correspondence Address: CHALKER FLORES, LLP, 2711 LBJ FRWY, Suite 1036, DALLAS, TX, 75234, US

(73) Assignee: FURTENBACH GMBH, Wiener Neustadt (AT)

(21) Appl. No.: 12/918,756

(22) PCT Filed: Feb. 5, 2009
(86) PCT No.: PCT/AT2009/000043

§ 371 Date: Oct. 20, 2010

(30) Foreign Application Priority Data
Feb. 22, 2008 (AT) A 296/2008

(51) Int. Cl. B05D 1/36; B05D 1/06

(52) U.S. Cl. 427/470

(57) ABSTRACT

The invention relates to a method for application of a refractory coating to lost forms, cores and other mineral and metal objects, wherein before application of the refractory coating, the lost forms, cores and other mineral and metal objects are made conducting by application of an electrolyte solution an coated with a solution, dispersion or suspension of a polymer and the refractory coating then applied in the form of a dry size by means of an electrostatic or tribostatic powder spray method and a dry size for use in said method.

The present invention relates to powder sizings and their composition, production, and application methods on lost molds, and to other mineral and metal objects (referred to hereafter as “objects to be coated”) in the casting industry.

The manufacturing methods of casting are generally differentiated according to the model set up, the molding compounds, the mold production, and the casting methods. Casting is primarily divided into two groups, namely
cast in lost mold and
casting in permanent molds.

Special methods are also low-pressure casting, composite casting, the bell founding method, art casting, and molding.

Lost molds (these are also understood to include casting cores hereafter) are typically produced from sand using suitable binders, so-called molding compounds.

A model, i.e., a pattern of the casting to be produced, is required for the shaping. One differentiates between permanent models and lost models for this purpose, permanent models being produced from plastic, wood, or metal depending on the requirement. They contain not only the likeness of the casting which is to be cast, but rather also the gate, i.e., the channels through which the casting material is poured into the mold and distributed and through which air contained in the mold and gases arising during the casting are exhausted. Permanent models are surrounded by molding sand, which is compacted by shaking and compression in such a way that it is stable. Castings are typically molded on both sides, and the mold is therefore divided into upper and lower boxes, so that the model can be removed again before the casting. Upper and lower boxes are then joined again in a precisely fitting way and the liquid casting material is poured into the mold thus resulting.

The binders of the molding sand are selected so that they are destroyed by the casting heat if possible, and the form thus collapses on its own, otherwise the mold must be mechanically destroyed in order to be able to remove the casting.

In contrast, lost models are not removed before the casting of the mold, and the mold can therefore be in one piece. The models are destroyed after the casting material is poured in, in that either they vaporize, melt out, or decompose in another way (e.g., polystyrene), or they are melted out before the casting (wax, artificial resins).

The molding compound used for manufacturing lost molds (and cores) comprises, as already noted above, a molding base material, a binder, and often further additives. The molding compound must be adapted in its composition to the mold and core production method (e.g., compaction, shaking), casting metal (e.g., casting temperature), and the purpose (e.g., greater gas permeability in the case of cores).

A large part of molds and cores also additionally receive a refractory coating after their production. These coatings result in a clean separation between the molding compound and the casting metal and a reduction of the surface roughness depth of the castings. They prevent the penetration of the casting metal into the molding compound and ensure sufficient erosion resistance of the mold surface. The typical wet coatings are sizings (blackings) and mold lacquers, which may be applied by painting, immersion, flooding, or spraying. Suspensions or dispersions of refractory materials are referred to in this case as sizings or blackings, which are applied in the form of a thin coating to cores, molds, or lost foam models, casting tools in the casting industry, and other mineral and metal objects.

The following may be achieved by application of the coating materials:
A smoothing of the surface,
a separation of core and casting material,
thermal insulation of the core/the mold as a protection from sudden heat stress of the sand, and
the prevention of undesired chemical and thermal reactions between core material and casting material.

The present invention relates to an application method of sizings to lost molds and cores, casting tools in the casting industry, and other mineral and metal objects.

After their preparation, a majority of the currently used conventional sizings comprise approximately 30-50% solvent (alcohol or water) or the conventional “dry sizings” are dissolved in solvents (alcohol or water), or more precisely suspended or dispersed, before the application.

Disadvantages of the conventional sizings are at the energy-intensive production and preparation, the uneven layer thickness after the application, the large material losses, the emission problems, the hazard class with respect to storage and transport (alcohol sizings), and the high transport costs.

From a technical aspect, the functionality of a sizing is dependent on the chemical composition of its components. The use of specific components, primarily mineral “filling agents”, is thus specified by the requirements of the user.

Fundamentally, there are two groups of sizings with respect to the carrier liquid:
a) Alcohol sizings, in which alcohol is used as the carrier liquid. The most frequently used alcohol is isopropanol, additives of other alcohols (such as ethanol and also methanol in some countries) being used to influence specific properties.
b) Water is used as the carrier liquid in water sizings.

The selection of the carrier liquid is primarily oriented to the employed binder system, the production sequence at the user, and the drying capability during the processing of the sizings.

Furthermore, regulatory requirements may make the use of alcohol sizings unprofitable or even forbid it. For reasons of work safety and environmental production, the demand for water sizings is therefore continuously increasing.

The sizings are classified as follows on the basis of their consistency and/or delivery form:
a) Finished sizings: offer a high degree of uniformity and little preparation work, are usable practically immediately.
b) Paste sizings: are typically diluted and require more preparation work than the finished sizings. The dilution is performed at the user.
c) Two-component systems (powder/paste): the dilution is performed at the user, however, a mixing facility is required for the finishing.
d) Powder sizings: are dry, their preparation (suspension or dispersion) is entirely performed at the user.

Fundamentally, all sizings, even finished sizings, must be prepared independently of their delivery form in order to make them ready for use. The effort for the preparation and error sources which are thus possible differ from one another, however.

The finished sizings are to be prepared because of the sedimentation occurring due to storage time and transport. Because the main preparation work was already performed by the producer using special mixing assemblies, the preparation in the casting facility is restricted solely to homogenization, which can primarily be performed directly in the delivery container. High shearing 120 forces are to be avoided to prevent possible changes of the flow behavior of the sizings. The excess liquid is never to be poured out before the preparation of the sizings, because the binders and additives, which decisively influence the technical application properties of the sizings, are dissolved in this excess.
Advantages: ready-to-use state, preparation very simple, constant preparation setting guaranteed by the producer;
disadvantages: high costs for the transport of the carrier liquid.

The same statements fundamentally apply for the paste sizings as for the finished sizings, because the main preparation work is also already performed at the manufacturer here. In this case, the final preparation at the user is more difficult because of the sizing consistency, since the required added quantity of carrier liquid is only absorbed by the paste with great difficulty. A remedy is provided here by mechanically breaking up the paste using suitable mixing assemblies. This delivery form is selected in order to be able to transport primarily water sizings economically. The preparation of the paste sizings is only to be performed in stages.
Advantages: transport cost savings, small number of error sources.
disadvantages: more difficult to homogenize than finished sizings, checking of the processing viscosity recommended after each preparation.

Two-component systems are provided in order to achieve a transport cost savings in relation to water sizings. The powder component is a mixture of filling agents and powdered additives, in contrast, the paste component is a mixture of suspension agent, filling agents, binders, and liquid additives. Due to the paste component, the swelling process of the suspension agent or thickener in the sizing is already completed, only a homogeneous mixing of paste, filling agents, and carrier liquid must still be performed. For this preparation, a stationary mixing facility having a corresponding stirring assembly (dissolver) is required.
Advantages: transport cost savings,
disadvantages: mixing facility required, preparation work-intensive, corresponding vacuum cleaning required.

In the case of powder sizings, the preparation is performed entirely at the user. In order to accelerate the swelling process, stirring assemblies which apply high shearing forces are recommended for this purpose. Without application of shearing forces, the swelling process of the ingredients is slowed enormously, but the quality of finished prepared sizings is not impaired. If the swelling process is not yet completed, however, problems may occur in the processing (immersion or painting behavior, irregularity of the applied sizings, etc.).
Advantages: greatest transport cost savings, high storage stability;
disadvantages: preparation at the consumer, large number of error sources, high-quality mixing assemblies required, preparation work-intensive, vacuum cleaning required.

As already noted, the sizings are typically applied by immersion, flooding, spraying, and painting to the molds, cores, and casting tools and to mineral and metal objects.

Immersion is currently the most rapid and cost-effective type of coating and can also be automated well by immersion robots during a constant molded part program. The advantage of the automated 170 immersion procedure is the regularity. With this type of coating, however, the coating of the core marks can have a disadvantageous effect, if the parts must be assembled into larger systems. A further disadvantage is the material loss during the procedure (dripping, immersion basin residues, etc.).

Flooding is an efficient coating method like immersion and is not only restricted to core parts. Automation of the work is possible with difficulty in the case of this method, and the uniformity of the applied layer is worse than in the immersion procedure. The coating of the core marks is also difficult to prevent. Material losses also occur with this type of coating.

Spraying is among the application methods having the highest losses in relation to the material use, further, additional work safety measures are required due to the spray mist. The layer thickness of the coating varies depending on the employees used and can result in casting flaws.

Painting is certainly the simplest but also the most time-consuming form of coating. An essential advantage of painting is that core marks and chills to not have to be coated. This form of sizing application is to be encountered primarily in large cores and molds which cannot absorb much carrier liquid. The layer thickness is dependent on both the experience of the particular employee and also the processing setting of the sizing.

According to WO 1980/01654 A1, a mixture made of refractory particles is completely coated using a polymer as a binder, after which these coated refractory particles are applied to molds by an electrostatic powder coat method.

DE 31 01 565 discloses electrostatic coating of a plastic film, the coating being applied on the side of the film facing toward the backfill mass, before the backfill mass is introduced, so that the sizing is located between plastic film and backfill mass (i.e., lost mold or core).

A method is described in U.S. Pat. No. 5,033,532, a dry, powdered insulating agent being layered on the surface of the mold in order to provide a porous insulating layer on the mold surface. Application of the insulating layer using electrostatic coating methods is provided, on the other hand, the document clearly discloses that the electrostatically applied insulating layer remains on the casting, the molten metal penetrating into the porous insulating layer and bonding thereto under the high applied pressure.

EP 1 669 475 relates to simple powder coating of a vehicle body part, the surface of the vehicle body part having been pretreated, for example, using a solution comprising zirconium and a silane.

The general background on the theory and practice of electrostatic spraying methods is summarized in Bailey: “The Science and Technology of Electrostatic Powder Spraying, Transport, and Coating”, Journal of Electrostatics, Elsevier Science Publishers B.V. Amsterdam, NL, vol. 45, pages 85-120, Oct. 12, 1998, XP004143550, ISSN 0304-3886.

The object of the present invention is to avoid the disadvantages connected to typical application methods for liquid sizings and, in a method for applying a refractory coating to lost molds, cores, and other mineral and metal objects, to exploit the advantages of the use of dry powder sizings simultaneously.

The object is achieved according to the invention in that in a method of the above-mentioned type, before application of the fire-resistant coating, the lost molds, cores, and other mineral and metal 220 objects are coated using a solution, dispersion, or suspension of a polymer, are made conductive via application of an electrolyte solution, and the fire-resistant coating is applied in the form of a dry sizing by an electrostatic or tribostatic powder spray process. In contrast to the method of the prior art, in the method according to the invention, the powder sizings are not dispersed or suspended in water or alcohol before their use, but rather are applied dry to the object to be coated. The application of the powder sizings is performed in a stationary, closed, emission-free and dust-free process having the corresponding facility apparatus. The component of the powder sizing which does not adhere on the object to be coated during the application is suctioned off and returned into the processing circuit. Powder coating or powder spraying is a coating method in which a material or object, which is typically electrically conductive, is coated using a suitable powder. The powder is sprayed electrostatically or tribostatically onto the substrate to be coated and subsequently fired. The object is to be degreased well beforehand in any case. In the tribostatic method, the powder particles are electrically charged by friction, in order to then be applied to the object to be coated by compressed air. The particles remain adhering to the object because of their electrical charge. When an electrostatic method is referred to hereafter, this is also understood to mean a tribostatic method. In the method according to the invention, before application of the fire-resistant coating to the lost molds, cores, and to other mineral and metal objects, these objects are coated using a solution, dispersion, or suspension of a polymer. “Polymers” in the meaning of the invention are all organic and inorganic polymer materials, independent of their chemical composition, which may be dissolved, dispersed, or suspended in water or organic solvent. The objects sprayed using polymer solution are supplied without drying to the application of the powder sizing. Thermoplastics and/or aminoplastics are preferably used. Thermoplastics have no cross-linking points and can be melted under the action of high temperature, but become solid again upon cooling, while aminoplastics, primarily urea and melamine resin, are duroplastics, but have the property of melting once and only once under the action of high temperature (flow point of the aminoplastic), and become solid upon a further action of high temperature. Furthermore, the surfaces of the object to be coated are made conductive before the application of the sizing via application of an electrolyte solution. The application can be performed by immersion, flooding, spraying, and/or painting, for example.

The objects are preferably dried after the application of the electrolyte solution and before the application of the sizing. Alternatively, the objects may also be electrostatically coated using the sizing without prior drying. Metal objects do not require any pretreatment per se, because their surface is intrinsically conductive.

Furthermore, it is advantageous if, in the method according to the invention, the refractory coating applied in the form of a dry sizing using the electrostatic powder spraying method is heated in a furnace having continuous or discontinuous charging, preferably using a heating method selected from the group comprising hot air heating methods, infrared heating methods, light impulse warming methods, and electron beam heating, and combinations thereof. During firing of the coated objects, the included polymer anchors with the surface of the object to be coated and forms a closed 260 polymer film having very good adhesion, which functions as a binder and binds the powdered filling agents of the sizing. The firing is performed, depending on the chemical composition of the included polymer, at temperatures between 100-400° C. After the heating or “firing” of the fire-resistant coating, the objects which are sized and/or coated in this way may be supplied to the casting process or stored either directly or after completed cooling.

When a thermoplastic or aminoplastic polymer is referred to hereafter, this means all polymers, notwithstanding the chemical composition, which change their phase from “solid” to “paste” or “liquid” through the action of high temperature. “Aminoplastic polymers” are generally understood as the condensation products of aldehydes (e.g., formaldehyde) with amines (e.g., urea/thiourea, melamine, cyanamide), such as urea, melamine, thiourea resins, etc.

Furthermore, it is preferred according to the invention that the dry sizing for use in this method comprises mineral filling agents, while avoiding rheological additives, such as suspension agents, thickeners, fluxing agents, or cross-linking agents. The powder sizings comprise—except for typical aids, especially for electrostatic powder spraying methods—practically only the mineral filling agents, without suspension agents, thickeners, fluxing agents, or cross-linking agents, which are not necessary in the method according to the invention.

The adhesion of the mineral filling agents on the objects to be coated and on the other mineral and metal objects occurs through the polymer solution, dispersion, or suspension, which is sprayed onto the surface of the objects to be coated.

The advantages of the present invention are:
A uniform distribution of the sizings on the molds, cores, and lost foam models used in the casting industry, or on mineral and metal objects.
Savings of raw materials, because no suspension agents, thickeners, cross-linking agents, defoaming agents, etc. are required in the powder sizings according to the invention.
The production of the powder sizings according to the invention is performed by homogeneous mixing of the employed raw materials. Digestion over several hours, as is required in the case of conventional sizings, is not necessary. A cost savings thus results with respect to personnel and energy costs.
The method according to the invention is a solvent-free or solvent-reduced process, in which no or an extremely reduced quantity of organic emissions arise.
Increased process safety and entirely dispensing with the sizing storage according to the Flammable Liquids Code (alcohol sizings).
Safer transport and handling of the powder sizings according to the invention and avoidance of hazardous material transports.
Material savings through the avoidance of wastes and dust emissions during the application of the powder sizings, because work is performed in a closed system.
Savings of transport costs, because approximately 50% solvent (alcohol or water) is transported in the case of the conventional, solvent-containing sizings.

The object of the present invention will be explained in greater detail by the following examples.

The method for applying the powder sizings according to the present invention to the cores, molds, and lost foam models in the casting industry and to other mineral and metal objects comprises the following steps, for example:

Pretreatment:

The objects to be coated are cleaned and their surface is made conductive using an electrolyte 320 solution. Metal objects do not require any pretreatment per se, because their surface is intrinsically conductive. An aqueous solution of an alkaline, alkaline earth, or metal salt or a diluted, aqueous solution of an organic or inorganic acid or base is used as the electrolyte solution according to the invention. The application can be performed, for example, by immersion, flooding, spraying, and/or painting, if desired, the objects are dried after the application of the electrolyte solution. It is to be ensured as much as possible that the objects to be coated do not form a Faraday cage, otherwise a tribostatic method is to be applied rather than an electrostatic method.

The objects to be coated are cleaned once again and their surface is coated using a thermoplastic or aminoplastic polymer solution by immersion, flooding, spraying, and/or painting. “Polymers” in the meaning of the invention means all organic and inorganic polymer materials, independent of their chemical composition, which may be dissolved, dispersed, or suspended in water or organic solvents, such as polyacrylates, polyvinyl alcohols and polyvinyl derivatives, phenol novolacs, urea and melamine resins, polyamines, polyamides, thermally curing oils, and natural polymers such as lignin derivatives, tannin derivatives, cellulose derivatives, starch derivatives, polysaccharides, soluble glasses, and inorganic polymers such as polysilicates and polyphosphates. The objects may be supplied to the application of the powder sizings without drying.

Application:

The sizings are provided in solid powdered or granulated form, and comprise a mixture of mineral filling agents, such as alkaline earth oxides, metal oxides, graphite, etc., in each case. The sizings can be used directly without further preparation. The powder spraying method (EPS method) for the sizing application is as follows:

Firstly, the powder sizing is fluidized using air, i.e., broken up using blasts of air, in a powder container. The air used may have a water vapor content of at most 1.3 g/m³. The air pressure is 5-12 bar. With the aid of injectors, the fluidized powder is conveyed from the container to spray guns, such as a commercial EPS hand spray gun having a ceramic nozzle, and electrostatically charged there using integrated high-voltage generation (rated input voltage 10 V eff., frequency 15-20 kHz, rated output voltage 100 kV, polarity negative) and expelled in the direction of the core, mold, lost foam model, or mineral or metal object to be coated. The electrostatic forces deflect the powder particles onto the objects to be coated.

The objects to be coated must be well grounded before beginning the spraying.

The component of the powder sizing which does not adhere on the object to be coated during the application (overspray) is suctioned off and returned into the processing circuit.

A variant which operates in the fluidized bed is especially also suitable for small parts.

The electrostatic charging of the powder particles can be performed using the following types of spray guns according to the present invention:
Corona spray guns (most widespread): The powder particles are negatively charged. A high voltage of approximately 100 kV is applied to the corona electrodes. Air ions are thus generated, which electrostatically charge the powder particles. Disturbances in the coating layer can possibly occur due to the “back spray effect”. This is caused by air ions which charge the deposited powder layer.
Tribo spray guns: The powder particles are positively charged. The powder particles become electrostatically charged through friction-electric actions during the turbulent flow through the spray guns. The coating success is strongly dependent on the coating material used in this technique.

An electrical field, which the powder particles follow, is generated between the grounded object, which was previously made conductive, such as a core, and the spray gun. Depending on the requirement, a sizing layer of 30-500 μm thus arises. The characteristic of the spray cloud has a decisive influence on the coating result. Suitable nozzle systems are available for the adaptation. Nozzle systems made of ceramic or stainless steel are particularly suitable in the method of the present invention.

Firing

During the firing of the coated objects, the polymers, which are contained in the polymer layer applied before application of the sizing, melt. The molten polymer anchors with the surface of the object to be coated and forms a closed polymer film having very good adhesion, which functions as a binder and binds the powdered filling agents of the sizing. The firing is performed at temperatures between 100-400° C. depending on the chemical composition of the included polymer.

Rapid and effective heating and thus firing of the applied sizing powder is desired. This can be achieved using hot air drying or radiant drying, for example.

The following heating methods suggest themselves for the “firing” of the powder sizing according to the present invention:

Hot air drying: Effective but slow heating and drying can also be achieved using conventional hot air drying.

Infrared: Is typically performed using infrared radiators, which emit a heat of 200° C. to 400° C. The 400 infrared radiation is absorbed or reflected from the coated objects depending on the composition and surface thereof. The non-reflected radiation component results in a rapid temperature increase of the powder sizing and the objects to be coated. The rapid heating of the powder sizing and the melting or flowing of the thermoplastic or aminoplastic polymer requires a precise maintenance of the heating time. Infrared heating is only to be applied in the case of continuous methods, in which the transport speed can be precisely adapted to the material to be dried, so that overheating of the coating does not occur at individual points of the object to be coated.

Light pulse heating method: Is a type of UV radiant heating method in principle. In the light pulse heating method, UV beams are bundled by reflectors and deflected as a parallel bundle onto the surface of the coated objects. It is thus possible to change the distance between the surface of the coated object and reflectors within the range of approximately 1000 mm. This type of heating is particularly suitable for polyester, polyurethane, or urea or melamine resins as the binder. The heating time is between 15 and 35 seconds.

Electron beam heating: This method is used for curing powder sizings which are more than 400 μm thick. They cure completely in fractions of seconds, because of which the method allows correspondingly high belt speeds. In this method, electrons are emitted by a tungsten wire and bundled in an electrical field. The bundled electrons (electron beam) sweep the entire width of the conveyor belt. The curing of the included polymer occurs without development of heat in an irradiation zone which is approximately 100 mm long. This method is only cost-effective for high throughput quantities. In addition, special safety precautions are required, because the radiation is very hazardous to humans.

After the treatment of the sized or coated objects in the furnace, they are supplied for further use or stored directly or after completed cooling.

The following wavelength ranges may be selected as needed according to the present invention:

Infrared (IR): wavelength range 1 mm to 800 nm; frequency range 3×10¹¹ to 3.75×10¹⁴ Hz.

Microwave (MW): wavelength range 1 m to 1 mm; frequency 300 MHz to 300 GHz.

The object of the present invention will be explained in greater detail by the following concrete examples. All specifications are in %-mass.

### EXAMPLE 1

### Coating of Sand Cores and Lost Foam Models

1.a. Pretreatment of the Cores:

The experiments were performed using cold box, hot box, and furan (no bake) sand cores and lost foam models. The objects to be coated were made conductive by immersion and/or spraying using various electrolyte solutions. Eight pieces each of cold box, hot box, furan (no bake) sand cores and lost foam models were pre-treated using each solution. Four pieces thereof were immersed and four were sprayed. The following solutions were used as the electrolyte solutions:

a) 5.0% MgSO₄ solution (pH 6.5).
b) 5.0% Na₂HPO₄ solution (pH 9.1).
c) 5.0% Na₂SO₄ solution (pH 5.5)
d) 5.0% Ni(CH₃COO)₂ solution (pH 5.5).
e) 5.0% FeSO₄ solution.
f) 10.0% citric acid (pH 1.8).

### g) 2.0% H₂SO₄ (pH 1.5).

### h) 1.5% H₃PO₄ (pH 1.8).

### i) 2% KOH (pH 12).

1.b. Drying of the Cores:

The cores and lost foam models were dried for 5 minutes at 120° C. using hot air drying.

1.c. Application of the Powder Sizing:

Four each of the pretreated sand cores and lost foam models were coated via the EPS method using powder sizings of the following composition.

Powder sizing 1 comprising:

zircon flour, aluminum silicate, Fe₂O₃ (without binder)

The comparison product is an alcohol sizing (i.e., identical composition but suspended in alcohol).

Powder sizing 2 comprising:

aluminum silicate, graphite, mica, sintered magnesite, bentonite, Fe₂O₃ (without binder)

The comparison product is a water sizing (i.e., identical composition but suspended in water).

The special composition of the sizings was selected, because such sizings are frequently used in the casting industry and the sizings contain components having very high or low density, such as zircon flour 3.9-4.8 g/cm³, mica 2.7-2.8 g/cm³, and graphite 2.1-2.3 g/cm³.

Firstly, the powder sizing was fluidized using air, i.e., broken up using blast of air in the powder container of the coating experimental facility. The air used had a water vapor content of 0.9 g/m³, and the air pressure was 8 bar.

The fluidized powder sizings were conveyed from the container to spray guns, such as a corona hand spray gun having ceramic nozzle, and electrostatically charged there using integrated high-voltage generation (rated input voltage 10 V effective, frequency 15-20 kHz, rated output voltage 100 kV, polarity negative) and expelled in the direction of the pretreated and grounded sand cores or the lost foam models.

The component of the powder sizing which did not adhere on the object to be coated during the application (overspray) was suctioned off and returned into the processing circuit.

1.d. Firing of the Powder Sizings:

The coated cores and lost foam models were treated using hot air drying for 15 minutes at 250° C. and IR drying for 5 minutes at 300° C.

The applied powder sizings have a thickness of 200-250 μm.

### Casting Results

The sand cores and lost foam models coated in example 1 were cast in gray cast iron in the casting facility.

Sand cores and lost foam models which were coated using the particular comparison product of alcohol or water sizing were used as the comparison.

The castings produced employing the powder-coated sand cores and lost foam models have the same quality as the castings produced employing the particular wet sizings.

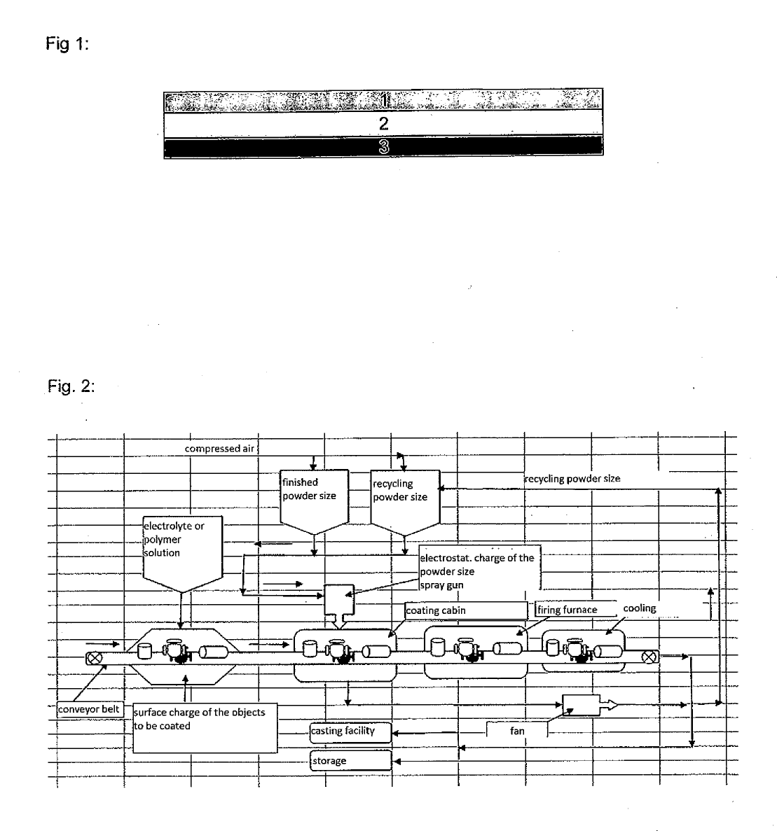

In the appended drawings, FIG. 1 shows a cross-section of a powder-sized object and FIG. 2 shows a mass production and automatically operating facility conceived according to the present invention for processing powder sizings according to the EPS method.

According to FIG. 1, a powder-sized object according to the invention is constructed in cross-section from the powder sizing (1), a conductive layer and polymer layer (2), and the object itself (3).

According to FIG. 2, a facility for processing powder sizings according to the EPS method comprises the following components:
pressurized container for storing the powder sizings.
pressurized container for the overspray (recycling material).
compressed air line (>6 bar).
conveyor system (conveyor belt).
   cabin for making the cores, molds, casting tools, and mineral objects conductive having spray unit.
   apparatus for the electrostatic charging of the powder sizings and spray guns.
coating cabin.
fan for suctioning and conveying the “overspray” (residual sizing).
firing furnace.
cooling facility.
required pipelines.

The structure of the facility is well known to a person skilled in the art upon viewing FIG. 2, so that it does not have to be discussed in greater detail here.

1. A method for applying a fire-resistant coating to lost molds, cores, and to other mineral and metal objects, characterized in that, comprising the steps of:
before application of the fire-resistant coating, the lost molds, cores, and other mineral and metal objects are made conductive via application of an electrolyte solution and are coated using a solution, dispersion, or suspension of a polymer, and
the refractory coating is then applied in the form of a dry sizing by an electrostatic or tribostatic powder spray process.

2. The method according to claim 1, characterized in that the objects are dried after the application of the electrolyte solution and before the application of the sizing.

3. The method according to claim 1, characterized in that the fire-resistant coating, which is applied using the electrostatic powder spray process in the form of a dry sizing, is heated in a furnace having continuous or discontinuous charging, preferably using a heating method selected from the group comprising hot air heating methods, infrared heating methods, light pulse heating methods, and electron beam heating, and combinations thereof.

4. Dry sizing for use in the method according to claim 2, characterized in that the sizing comprises mineral filling agents, while avoiding rheological additives, such as suspension agents, thickeners, fluxing agents, or cross-linking agents.
